(19) United States
(12) Patent Application Publication
(10) Pub. No.: US 2025/0095453 A1
(43) Pub. Date: Mar. 20, 2025

(54) SYSTEM FOR IMPLEMENTING A SCRATCH-OFF LOTTERY TICKET GAME

(71) Applicant: William John Parei, Winnipeg (CA)

(72) Inventor: William John Parei, Winnipeg (CA)

(21) Appl. No.: 18/826,367

(22) Filed: Sep. 6, 2024

Related U.S. Application Data
(60) Provisional application No. 63/583,032, filed on Sep. 15, 2023.

(51) Int. Cl. G07F 17/32

(52) U.S. Cl. CPC G07F 17/329

(57) ABSTRACT

To encourage play of scratch-off lottery tickets in a common lottery game with a common linking theme a control system prints a set of tickets having a prize structure and a purchase price structure determined by the system. The set includes a plurality of subsets where the purchase price of the tickets is different from the purchase price of at least one other subset. Each ticket defines at least a minimum prize where the minimum prize has a value less than the purchase price thereof. The system arranges the purchase price of the tickets in the subsets such that the purchase prices of the subsets form a series of descending purchase prices from each subset to a next lower subset in the series; and such that the minimum prize of each subset matches or is correlated to the purchase price of a next lower subset.

This application claims the benefit under 35 USC 119 (e) of Provisional Application 63/583,032 filed Sep. 15 2023.

The present invention generally relates to a system for implementing a scratch-off lottery ticket game, and more particularly to a system that encourages purchase and play of the scratch-off lottery tickets by customers of the game.

### BACKGROUND OF THE INVENTION

Some lottery jurisdictions around the world are experiencing flat (if not declining) sales, particularly in older, traditional games such as ‘scratch and win’. With scratch and win tickets, in an effort to entice customers to continue purchasing, lotteries have been implementing different strategies to increase ticket ‘play value’. Some strategies include:
-1- Increase the number of prizes by moving away from higher value prizes and distributing the money as a larger number of lower value prizes. This provides better odds of winning to the players.
-2- Opposite from number 1 above, increase the size of the major prize, i.e. to $1,000,000 (or more). This generally requires a larger pool size and works better for higher cost tickets.
-3- Make the games more complicated so tickets take longer to play (for example, crossword or bingo).
-4- Introduce ‘free tickets’ as a prize, giving players additional tickets to play. This allows the lottery to book the prize at the theoretical prize value.
-5- Increase the Prize Fund percentage. Instead of returning 60% to players, the return percentage could be increased to 62%, or 64%. The problem with this approach is that lotteries have costs associated with scratch and win tickets; cost of printing the tickets, distribution costs, sales commission to the sellers, etc. Lotteries must continue to make profits for the governments or the charities they support. Thus, they must find a balance between the Prize Fund percentage Prize Distribution and method of play in an attempt to satisfy the wants of the players while still maximizing profits.

### SUMMARY OF THE INVENTION

According to the invention there is provided a system to encourage play of scratch-off lottery tickets in a lottery comprising:
a total set of scratch-off lottery tickets generated by the system:
the total set of scratch-off lottery tickets comprising a plurality of subsets of the lottery tickets arranged for sale by the system where the plurality of subsets comprises a series of at least three subsets including a first subset and at least two further subsets;
wherein each of the scratch-off lottery tickets of the subsets has a purchase price determined by the system;
each of the first subset and the further subsets having defined by the system the purchase price of the lottery tickets thereof such that each of the at least three subsets has a purchase price of the lottery tickets thereof which is different from the purchase price of the other subsets;
the lottery tickets of each of the subsets having defined by the system to have a predetermined outcome of a set of prizes to be won in the lottery;
substantially all of the lottery tickets of the first subset having defined by the system as said predetermined outcome thereof at least a minimum prize where the minimum prize has a value less than the purchase price thereof;
substantially all of the lottery tickets of at least one of the further subsets having defined by the system as said predetermined outcome thereof at least a minimum prize where the minimum prize has a value less than the purchase price thereof;
wherein the system arranges the purchase price of the tickets in the at least three subsets such that the purchase prices of the at least three subsets form a series of descending purchase prices;
wherein the system is arranged such that the minimum prize of the lottery tickets of the first subset is related to the purchase price of the lottery tickets of the other subsets so that either the minimum prize from the lottery tickets of the first subset provides a value which is equal to the purchase price of one of the further subsets or the minimum prize of the first subset is equal to the sum of the purchase price of two or more of the further subsets.

Preferably, for at least some of the subsets, the value of the minimum prize is directly equal to the purchase price of the next lower subset in the series.

That is, preferably for each of the at least three subsets, the minimum prize from the lottery tickets of the subset provides a value which is directly equal to the purchase price of a next one of the subsets in the descending series. In this way the player receiving the minimum prize is encouraged to purchase a lottery ticket from another subset in the set. The intention is that the player receiving the minimum prize of each subset moves on down the series to the last subset of the lowest purchase price where those tickets typically would not include a minimum prize.

In a case where the minimum prize is not directly equal to the purchase price of another subset in the series, for at least some of the subsets, the minimum prize from the lottery tickets of the subset provides a value which is equal to the sum of the purchase price of two of the further subsets. In this way the intention is that the player receiving that minimum prize purchases the tickets from the two of the subsets and again moves down the series.

In order to maintain a proper prize distribution bearing in mind the different purchase prices it is desirable that each of the subsets has a separate prize structure.

In order to encourage the player to continue in the same set through the different subsets, preferably all of said subsets are supplied as a set with a common linking theme or appearance so as to be clearly visually related each to the others.

Thus it is typically not necessary that each of the subsets has the same prize structure or same prize pool. It is possible to look at the subsets in totality and design a prize structure across all subsets including multiple separate prize pools. Thus said at least one prize structure may include a number of separate prize structures of different character.

Also each of the subsets can typically be structured or purchased as a stand-alone game. The key point is that the subsets of tickets have a common theme, common graphics and common name showing or indicating to the customers that all are linked as a common game.

Preferably for at least some of the subsets, the value of the minimum prize awarded of one subset is directly equal to the purchase price of the next lower subset.

Preferably each subset has the minimum prize and the purchase price of the next lowest subset is arranged at whole number of dollars declining to a minimum purchase price of one dollar for a last subset in the series.

### BRIEF DESCRIPTION OF THE DRAWING

FIG. 1 is a schematic illustration of the cascade or descending series of purchase price point values for the series subsets of tickets.

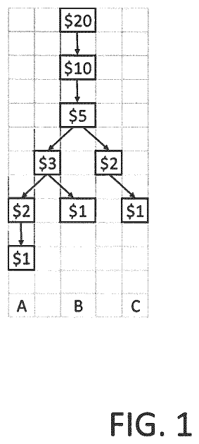

FIG. 2 is schematic illustration of the system which prints the tickets of the game at the purchase price point values and minimum prize values for the series subsets of tickets.

### DETAILED DESCRIPTION

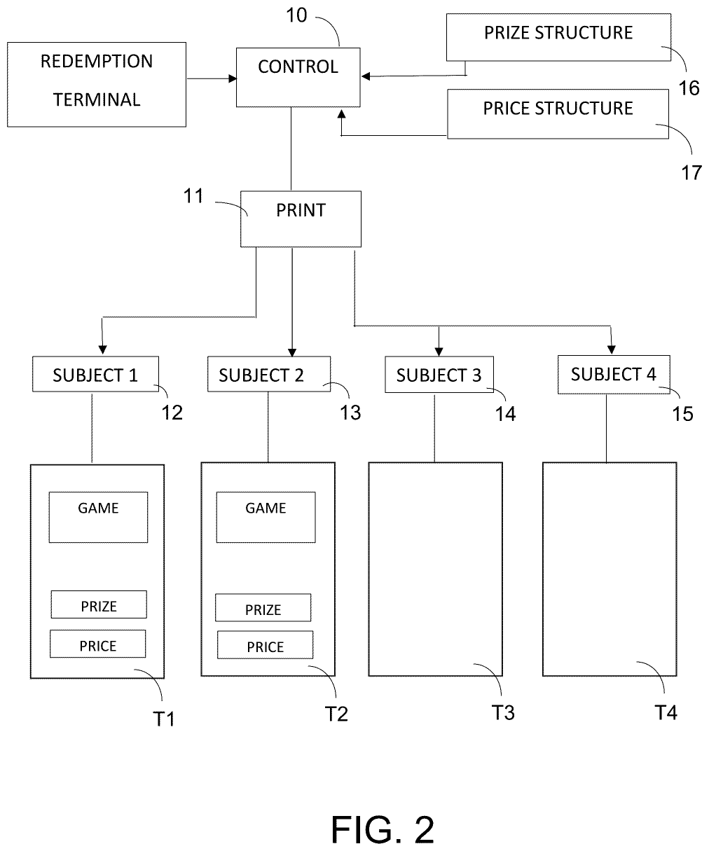

As shown in FIG. 2, the system herein provides a control computer 10 which manages and controls the game including of the printing of the tickets and allocation between the tickets of the prize structure.

The control system 10 controls the printer 11 to print the tickets T1, T2, T3 and T4 into a series of subsets 12, 13, 14 and 15 of the tickets.

A data base 16 providing a prize structure is arranged to contain at least one multi-tier prize structure which is applied by the system to the game that includes at least one top tier prize and a plurality of prizes at lower tier prize levels so that each of the scratch-off lottery tickets has a predetermined outcome from the prize structure.

A data base 15 providing a price structure is arranged to contain each for each of the sets of the scratch-off lottery tickets a purchase price determined by the system. In this way, the plurality of subsets are all being arranged for sale by the system as part of the common lottery game.

Each subset has the purchase price of the tickets thereof such that at least one subset of the of the total set of scratch-off lottery tickets has a purchase price of the lottery tickets of the subset which is different from the purchase price of at least one other subset of the of the total set. Typically each ticket of each subset of the of has defined by the system as the outcome thereof at least a minimum prize where the minimum prize has a value less than the purchase price thereof and such that the purchase prices of the subsets form a series of descending purchase prices from each subset to a next lower subset in the series. In this arrangement, the system is arranged such that the minimum prize of each subset matches or is correlated to the purchase price of a next lower subset or another subset.

The arrangement herein thus provides a method in which there is provided additional play value to customers by introducing a scratch and win ticket in effect every ticket wins a prize. Some tickets may not carry a minimum prize where the system does not require this, such as some tickets irrelevant to the operation of the system or the tickets of the lowest cost subset.

Secondly, the system acts to put these tickets onto the market in a series of descending price points for example $20, $10, $5, $3, and $2 all sold using a common theme or as part of a common game and with a common prize structure for the game so the customer clearly understands that the tickets, even though they are of different denominations, are all ‘linked’ together. This linkage can be completed through a common design or name. The prize fund at each price point is structured such that the minimum prize cascades or descends to the next lower price point, as follows:

| Price of the Ticket | Minimum Prize of Every Ticket |
|---|---|
| $20 | $10 |
| $10 | $5 |
| $5 | Half at $3 and half at $2(1) |
| $3 | Half at $2 and half at $1(1) |
| $2 | $1 |

As $5 and $3 they are not evenly divisible by 2, these tickets require a mixture of minimum prize values.

In the arrangement herein, where in effect or substantially every ticket is a winner, having to meet a specific prize fund percentage significantly affects the Prize Distribution. As one example:
Ticket Cost=$20, Pool size=500,000 tickets, Minimum Prize=$10, Prize Fund %=70%

If 100% of the tickets in this pool were sold, total sales would be $10,000,000 with the minimum prizes accounting for almost 50%, or $5,000,000. The total Prize Fund would be $7,000,000. So for the remaining $2,000,000 in prizes there are various options for distribution of this money which allows the lottery to tailor the game to meet their desired player demographic. Two options are:

$20 Option 1
(pool = 500,000 tickets)

| | Odds 1 in | # of | Prize | |
|---|---|---|---|---|
| Prize | x | prizes | Value | Total Value |
| $100,000 | 50,000 | 10 | $100,000 | $1,000,000 |
| $10,000 | 250,000 | 2 | $5,000 | $10,000 |
| $1,000 | 50,000 | 10 | $1,000 | $10,000 |
| $500 | 750 | 667 | $500 | $333,500 |
| $200 | 500 | 1,000 | $200 | $200,000 |
| $120 | 500 | 1,000 | $120 | $120,000 |
| $100 | 500 | 1,000 | $100 | $100,000 |
| $50 | 125 | 4,000 | $50 | $200,000 |
| $20 | 50 | 10,000 | $20 | $200,000 |
| $10 | 1 | 482,311 | $10 | $4,823,110 |
| Total | 1.00 | 500,000 | | $6,996,610 |
| | | 100.00% | | 69.97% |

$20 Option 2
(pool = 500,000 tickets)

| Prize | Odds 1 in x | # of prizes | Prize Value | Total Value |
|---|---|---|---|---|
| $1,000,000 | 500,000 | 1 | $1,000,000 | $1,000,000 |
| $500,000 | 500,000 | 1 | $500,000 | $500,000 |
| $250,000 | 500,000 | 1 | $250,000 | $250,000 |
| $1,000 | 50,000 | 10 | $1,000 | $10,000 |
| $100 | 10,000 | 50 | $100 | $5,000 |
| $50 | 100 | 5,000 | $50 | $250,000 |
| $20 | 100 | 5,000 | $20 | $100,000 |
| $10 | 1 | 489,937 | $10 | $4,899,370 |
| Total | 1.00 | 500,000 | | $7,014,370 |
| | | 100.00% | | 70.14% |

It can be seen from the two options above that it is possible to achieve:
A 1:1 ratio of winning tickets, i.e. every ticket wins a prize;
A minimum prize valued at or close to 50% of the face value of the ticket;
Provision of higher value prizes if desired;
The overall Prize Fund % at or close to 70%.

Most scratch ticket players are looking for play value and will generally play their winnings down to zero unless they win a ‘life changing’ prize. This life changing amount will vary widely from person to person.

The arrangement herein provides a series of common themed tickets in a common game at different price points. This, coupled with the concept of every ticket being a winner, provides significant additional play value and uniqueness. For an investment of $20, a player has a chance at winning $1,000,000 at the same time knowing they would win a minimum of $10. They can reinvest this $10 for more play value and for a chance to win $500,000 while knowing they're guaranteed a minimum win of $5. They can then reinvest the $5, etc. And so it goes.

The system stops at the $1 ticket level as most lottery jurisdictions do not want to deal with half dollar prizes. Providing a reasonably sized guaranteed prize for a $1 ticket is not feasible. Thus the cascade ends with a ticket valued at $2. However, it's likely that most players would take the guaranteed $1 prize and re-invest it into another $1 ticket (which has an overall prize value of $0.60 assuming the Prize Fund % is 60).

| | A | B | C | D | E | F | G | H | I |
|---|---|---|---|---|---|---|---|---|---|
| Initial | $20 | $20 | $20 | $10 | $10 | $10 | $5 | $5 | $5 |
| Investment | | | | | | | | | |
| from | | | | | | | | | |
| customer | | | | | | | | | |
| Prize then | $10 | $10 | $10 | $5 | $5 | $5 | $3 | $3 | $2 |
| reinvested | | | | | | | | | |
| Prize then | $5 | $5 | $5 | $3 | $3 | $2 | $2 | $1 | $1 |
| reinvested | | | | | | | | | |
| Prize then | $3 | $3 | $2 | $2 | $1 | $1 | $1 | — | — |
| reinvested | | | | | | | | | |
| Prize then | $2 | $1 | $1 | $1 | — | — | — | — | — |
| reinvested | | | | | | | | | |
| Prize then | $1 | — | — | — | — | — | — | — | — |
| reinvested | | | | | | | | | |
| Prize | $.60 | $.60 | $.60 | $.60 | $.60 | $.60 | $.60 | $.60 | $.60 |
| # of | 6 | 5 | 5 | 5 | 4 | 4 | 4 | 3 | 3 |
| Tickets | | | | | | | | | |
| Played | | | | | | | | | |
| Total | $41 | $39 | $38 | $21 | $19 | $18 | $11 | $9 | $8 |
| ‘Sales’ | | | | | | | | | |
| Total | $21.60 | $19.60 | $18.60 | $11.60 | $9.60 | $8.60 | $6.60 | $4.60 | $3.60 |
| Prizes | | | | | | | | | |
| Net Win | $19.40 | $19.40 | $19.40 | $9.40 | $9.40 | $9.40 | $4.40 | $4.40 | $4.40 |

The system herein acts to implement a new scratch ticket category where every ticket relevant to this system of operation is guaranteed to win a prize. Use multiple price points, where the tickets at different price points are themed together to provide an awareness of the prize cascade. Ideally this new concept entices a new type of customer to play scratch tickets. This new category provides additional play value to customers and increase sales.

The concept provides customers with a 100% winning experience for when they want to provide friends or relatives with tickets as a gift (most people do not like giving away losing tickets).

In the new category, various themes can be selected such as for various holidays, such as Christmas, Chinese New Year; Thanksgiving; Birthday Theme, etc.

The following charts provide examples of suitable ticket pricing structures: They show in a generic way that there are multiple subsets (X subsets), each subset having a retail price P which preferably is the same as the lowest tier prize V of the subset right before it. Each subset has N different prizes where N can be different by subset. Preferably there is a 1:1 ratio of tickets to winners.

Ticket 1 - Retail Price (P1)
Pool of (T1) Tickets

| | Value | Quantity | Winning |
|---|---|---|---|
| # | (V1) * | (Q1) | Ratio |
| 1 | V1₁ | Q1₁ | Q1₁:T1 |
| 2 | V1₂ | Q1₂ | Q1₂:T1 |
| 3 | V1₃ | Q1₃ | Q1₃:T1 |
| 4 | V1₄ | Q1₄ | Q1₄:T1 |
| . | . | . | . |
| . | . | . | . |
| . | . | . | . |
| N | V1_{N} | Q1_{N} | Q1_{N}:T1 |
| Total | | T1 | T1:T1 or 1:1 |

* In descending order by value

Ticket 2 - Retail Price (P2 = V1_{N})
Pool of (T2) Tickets

| | Value | Quantity | Winning |
|---|---|---|---|
| # | (V2) * | (Q2) | Ratio |
| 1 | V2₁ | Q2₁ | Q2₁:T2 |
| 2 | V2₂ | Q2₂ | Q2₂:T2 |
| 3 | V2₃ | Q2₃ | Q2₃:T2 |
| 4 | V2₄ | Q2₄ | Q2₄:T2 |
| . | . | . | . |
| . | . | . | . |
| . | . | . | . |
| N | V2_{N} | Q2_{N} | Q2_{N}:T2 |
| Total | | T2 | T2:T2 or 1:1 |

Ticket 3 - Retail Price (P3 = V2_{N})
Pool of (T3) Tickets

| | Value | Quantity | Winning |
|---|---|---|---|
| # | (V3) * | (Q3) | Ratio |
| 1 | V3₁ | Q3₁ | Q3₁:T3 |
| 2 | V3₂ | Q3₂ | Q3₂:T3 |
| 3 | V3₃ | Q3₃ | Q3₃:T3 |
| 4 | V3₄ | Q3₄ | Q3₄:T3 |
| . | . | . | . |
| . | . | . | . |
| . | . | . | . |
| N | V3_{N} | Q3_{N} | Q3_{N}:T3 |
| Total | | T3 | T3:T3 or 1:1 |

Ticket X-1 - Retail Price (PX-1 = VX-2_{N})
Pool of (TX-1) Tickets

| | Value (VX- | Quantity | Winning |
|---|---|---|---|
| # | 1) * | (Q3) | Ratio |
| 1 | VX-1₁ | QX-1₁ | QX-1₁:TX-1 |
| 2 | VX-1₂ | QX-1₂ | QX-1₂:TX-1 |
| 3 | VX-1₃ | QX-1₃ | QX-1₃:TX-1 |
| 4 | VX-1₄ | QX-1₄ | QX-1₄:TX-1 |
| . | . | . | . |
| . | . | . | . |
| . | . | . | . |
| N | VX-1_{N} | QX-1_{N} | QX-1_{N}:TX-1 |
| Total | | TX-1 | TX-1:TX-1 or |
| | | | 1:1 |

Ticket X - Retail Price (PX = VX-1_{N})
Pool of (TX) Tickets

| | Value | Quantity | Winning |
|---|---|---|---|
| # | (VX) * | (Q3) | Ratio |
| 1 | VX₁ | QX₁ | QX₁:TX |
| 2 | VX₂ | QX₂ | QX₂:TX |
| 3 | VX₃ | QX₃ | QX₃:TX |
| 4 | VX₄ | QX₄ | QX₄:TX |
| . | . | . | . |
| . | . | . | . |
| . | . | . | . |
| N | VX_{N} | QX_{N} | QX_{N}:TX |
| Total | | TX | TX:TX or |
| | | | 1:1 |

1. A system to encourage play of scratch-off lottery tickets in a lottery comprising:
a total set of scratch-off lottery tickets generated by the system for the game:
the total set of scratch-off lottery tickets comprising a plurality of subsets of the lottery tickets arranged for sale by the system where the plurality of subsets comprises a series of at least three subsets including a first subset and at least two further subsets;
wherein each of the scratch-off lottery tickets of the subsets has a purchase price determined by the system;
each of the first subset and the further subsets having defined by the system the purchase price of the lottery tickets thereof such that each of the at least three subsets has a purchase price of the lottery tickets thereof which is different from the purchase price of the other subsets;
the lottery tickets of each of the subsets having defined by the system to have a predetermined outcome of a set of prizes to be won in the lottery;
substantially all of the lottery tickets of the first subset having defined by the system as said predetermined outcome thereof at least a minimum prize where the minimum prize has a value less than the purchase price thereof;
substantially all of the lottery tickets of at least one of the further subsets having defined by the system as said predetermined outcome thereof at least a minimum prize where the minimum prize has a value less than the purchase price thereof;
wherein the system arranges the purchase price of the tickets in the at least three subsets such that the purchase prices of the at least three subsets form a series of descending purchase prices;
wherein the system is arranged such that the minimum prize of the lottery tickets of the first subset is related to the purchase price of the lottery tickets of the other subsets so that either the minimum prize from the lottery tickets of the first subset provides a value which is equal to the purchase price of one of the further subsets or the minimum prize of the first subset is equal to the sum of the purchase price of two or more of the further subsets.

2. The system according to claim 1 wherein for at least some of the subsets, the value of the minimum prize is directly equal to the purchase price of another lower subset in the series.

3. The system according to claim 1 wherein for at least some of the subsets the minimum prize from the lottery tickets of the subset provides a value which is equal to the sum of the purchase price of two of the further subsets.

4. The system according to claim 1 wherein for each of the at least three subsets the minimum prize from the lottery tickets of the subset provides a value which is equal to the purchase price of a next one of the subsets in the descending series.

5. The system according to claim 1 wherein each of said subsets has a separate prize structure.

6. The system according to claim 1 wherein all of said subsets are supplied as a set with a common linking theme or appearance so as to be clearly visually related each to the others.
